(19) United States
(12) Patent Application Publication
(10) Pub. No.: US 2025/0230920 A1
(43) Pub. Date: Jul. 17, 2025

(54) AN INSERT FOR A LIGHT EMITTING DEVICE

(71) Applicant: SIGNIFY HOLDING B.V., EINDHOVEN (NL)

(72) Inventors: OLIVER FRANCIS BURKE, EINDHOVEN (NL); MARCEL BEIJ, SINT OEDENRODE (NL); BARRY MOS, Bocholt (BE); MARCUS THEODORUS MARIA LAMBOOIJ, EINDHOVEN (NL)

(21) Appl. No.: 18/875,689

(22) PCT Filed: Jun. 21, 2023
(86) PCT No.: PCT/EP2023/066825

§ 371 Date: Dec. 16, 2024

(30) Foreign Application Priority Data
Jun. 28, 2022 (EP) 22181407.2

(51) Int. Cl. F21V 11/06

(52) U.S. Cl. CPC F21V 11/06

(57) ABSTRACT

The present invention relates to a light emitting device (1) comprising a substrate (2) comprising a plurality of individually controllable light sources (3) adapted for, in operation, emitting light, and at least one insert (4) comprising at least partially light-blocking material and having a longitudinal extension being parallel to the substrate (2). The insert (4) comprises a plurality of transverse elements (5) having a proximal end (5′) arranged in proximity of the substrate (2) and a distal end (5″) arranged at a distance from the proximal end (5′). The transverse elements (5) are substantially perpendicular to the substrate (2), the plurality of transverse elements (5) dividing the substrate into at least a first segment (6′) comprising a first group of the light sources (3′), a second segment (6″) comprising a second group of the light sources (3″), and a third segment (6′″) comprising a third group of light sources (3′″).

### FIELD OF THE INVENTION

The invention relates to a light emitting device comprising an insert and to a luminaire comprising such a light emitting device.

### BACKGROUND OF THE INVENTION

LED lighting tiles designed to fit in drop ceilings are typically backlit using an array of LEDs on the rear of the panel. Alternatively, side-lit panels use a lightguide plate to distribute the light from LEDs mounted on the side of the panel. The arrangement of LEDs in a back-lit panel, e.g. Philips Ledinaire (600 mm×600 mm), may be in 6 rows each comprising 9 LEDs.

Further, it is known to provide a pattern tile having an insert dividing the tile in two individually controllable segments. Such pattern tiles may be combined in different configurations and operated such that an illumination pattern is obtained. To achieve this effect, it is important to have a good contrast between the illuminated and non-illuminated regions of the tile. This can be done by segmenting the tile using a light blocking element and addressing the LEDs within each segment separately.

However, there is still a need for an improved insert to be used with a LED panel, such that diversity of patterns obtainable by operating different segments of the LED panel may be increased.

US20080285280A1 discloses a lighting module comprising an array of LEDs arranged on a carrier, a mesh arranged at the carrier, and a front diffuser plate arranged in front of the mesh.

### SUMMARY OF THE INVENTION

It is therefore an object of the invention to provide a light emitting device comprising an insert, such that an increased flexibility in patterns obtainable by the light emitting device is provided. To this end, the present invention provides a light emitting device comprising a substrate comprising a plurality of individually controllable light sources adapted for, in operation, emitting light. The plurality of light sources may be arranged in straight parallel rows, circles, rectangles or in any other desired pattern across the substrate. The light sources may be LED light sources. Arranging the light sources in parallel rows offers the advantage of a simplified insert configuration.

The light emitting device further comprises at least one insert comprising at least partially light-blocking material, e.g. semi-transparent material.

The insert has a longitudinal extension being parallel to the substrate. The longitudinal extension of the insert is preferably the same as or slightly shorter than the longitudinal extension of the substrate. The insert comprises a plurality of transverse elements having a proximal end (i.e. a proximal edge) arranged in proximity of the substrate and a distal end (i.e. a distal edge) arranged at a distance from the proximal end. The distance between the proximal end and the distal end may be from 1 cm to 20 cm. The transverse elements are arranged substantially perpendicularly to the substrate. By the term “substantially perpendicularly” is meant being arranged at 90° relative to the substrate or arranged at an angle slightly deviating from 90° relative to the substrate. For instance, the transverse element may be arranged at an angle from 80° to 100° relative to the substrate. It is further conceivable that the transverse elements are arranged at different angles relative to the substrate. Such an embodiment offers the advantage of enhanced optical performance of the light emitting device.

The plurality of transverse elements divides the substrate into at least a first segment comprising a first group of the light sources, a second segment comprising a second group of the light sources, and a third segment comprising a third group of light sources. The different groups of light sources may be operated individually such that desired pattern is created. The number of segments may be at least five, at least ten or at least fifteen. Increased number of segments provides for an increased number of available patterns.

The plurality of transverse elements may be arranged in a straight configuration, in curved configuration, or in a combination thereof. The transverse elements may be intersecting.

The plurality of transverse elements may be integrally formed as a single piece, thus forming a single insert. Alternatively or additionally, the transverse elements may be formed as separate parts. In such an embodiment, the transverse element may be mutually connected and/or arranged on the substrate in a specific pattern to form the at least one insert at a later stage of the manufacturing/assembling step of the light emitting device.

Each transverse element of the plurality of transverse elements has a length Ld in the longitudinal direction essentially parallel to the plane of the substrate, a thickness T, and a height H from the proximal end to the distal end. The thickness T and the height H are measured perpendicular to the light direction. The height H of the transverse elements is measured substantially perpendicularly to the plane of the substrate, e.g. 90°±10° to the substrate. The length, height and/or thickness of each transverse element may be same as or different from the length, height and/or thickness of the other transverse elements.

The distal end of each transverse element may have a straight or smoothly curved shaped profile which is different from the shaped profile of the proximal end of each transverse element which may be straight, stepped straight or stepped curved. Stepped straight or stepped curved configuration offers the advantage of avoiding intersection of the transverse elements with the light generating/emitting part of any light source of the plurality of light sources while these light sources can still be advantageously arranged, for example in a convenient, square grid. Viewed in projection on a plane along the height of the transverse elements, in the embodiment wherein, for example, the proximal end has a stepped profile and the distal end is smoothly curved, the transverse element gradually transforms/changes in shape over its height from the stepped profile to a different, for example smooth, profile.

The light emitting device may comprise a light exit window being arranged substantially parallelly to the substrate such that the distal end of the at least one transverse element is arranged in proximity of or in contact with the light exit window by which cross-talk (light leakage) between neighboring segments is counteracted. If the distal end of the transverse element is arranged in proximity of the light exit window, the distance between the distal end of the transverse element and the light exit window preferably should not exceed the thickness of the distal end of the transverse element.

The light exit window may be a diffuse transmissive sheet. Alternatively, or additionally, the light exit window may be a light collimating plate. Depending on the beam profile for a specific desired function of the light emitting device, such an embodiments offer the advantage of improved matching optical performance.

The distal end of the transverse element may have a thickness below 0.2 mm. Such an embodiment offers the advantage of providing a virtually invisible insert, in particular when the light emitting device further comprises a light exit window panel arranged in proximity of or in contact with the distal end of the transverse element. It should be noted that the thickness of the transverse elements may be non-uniform. In particular the transverse elements may have a thickness decreasing from the proximal end to the distal end.

The insert may comprise a frame, and the transverse elements may be arranged within the frame. The frame may have any suitable shape and size, e.g. rectangular, square, oval, circular or the like. The frame may facilitate manufacturing, transportation and installation of the insert.

In order to reduce absorbance of light and ensure that that the insert is not visible through the light exit window panel, at least one transverse element in the plurality of transverse elements may comprise a reflective coating. Preferably, all of the transverse elements comprise reflective coating. Such an embodiment offers the advantage of providing improved optical performance of the light emitting device.

Depending on the configuration of the light sources and the transverse elements of the frame, at least one light source may become covered by a transverse element, which impairs the contrast between the segments of the light emitting device resulting in a poor optical pattern. In order to avoid this undesired effect, the proximal end of at least one transverse element may be non-straight. In such an embodiment, the proximal end of the at least one transverse element would not intersect any light source of the plurality of light sources. The term “non-straight” in the context of the present invention may mean a stepped or a zig-zac configuration.

In order to maximize optical efficiency, at least the distal ends of at least one transverse element may be white. Furthermore, it may be important to ensure that the light emitted by the light sources does not pass from the luminated to the non-luminated segment. Then the transverse elements should be fully blocking for light, either by absorption and/or reflection, for example in that semi-transparent material of the transverse elements is coated with a reflective, non-transparent coating.

The insert of the present invention may be manufactured by 3D printing, e.g. by means of fused deposition moulding (FDM). Alternatively, the insert may be manufactured by means of injection moulding.

The present invention further relates to a luminaire comprising a light emitting device according to the above. The luminaire may further comprise a fixation element configured to support the light emitting device. Such a fixation element may be a wire, a screw, a hook, or the like. In a particular embodiment, the luminaire is configured for a suspended configuration.

### BRIEF DESCRIPTION OF THE DRAWINGS

This and other aspects of the present invention will now be described in more detail, with reference to the appended drawings showing embodiments of the invention.

FIG. 1 shows a perspective view of a light emitting device comprising insert according to the present invention;

FIG. 2 shows a cross-sectional view of a light emitting device according to the invention;

FIGS. 3A-3C show different patterns obtainable in the light emitting device according to the present invention;

FIGS. 4A and 4B illustrate the embodiment of the insert of the present invention providing improved pattern edges;

FIG. 5A-6B show different embodiments of the insert similar to the one shown in FIGS. 4A-4B.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

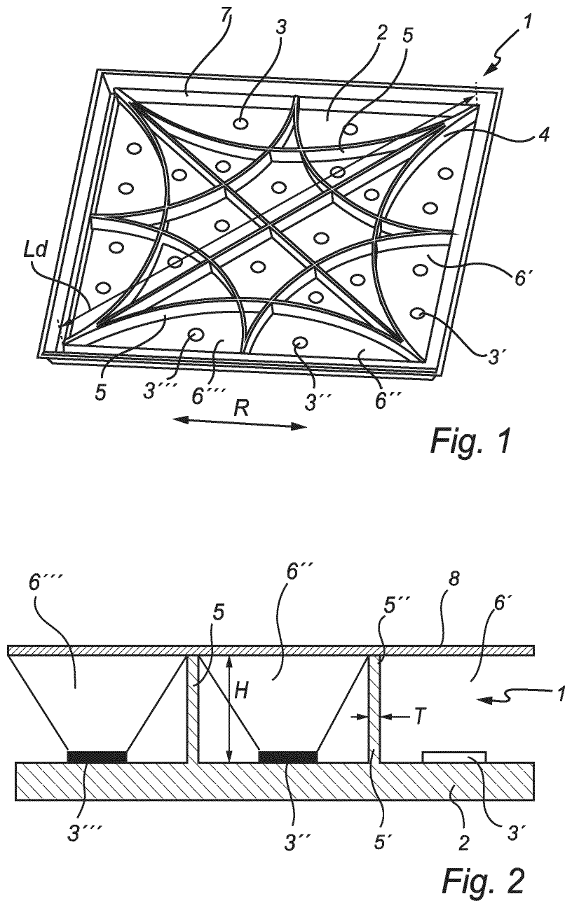

FIG. 1 illustrates a light emitting device 1 comprising a substrate 2 comprising a plurality of individually controllable light sources 3 adapted for, in operation, emitting light. The plurality of light sources 3 is arranged in rows.

The light emitting device 1 further comprises an insert 4 comprising at least partially light-blocking material, e.g. semi-transparent material.

The insert 4 has a longitudinal extension R being parallel to the substrate 2. The longitudinal extension R of the insert is the same as the longitudinal extension of the substrate 2. The insert 4 comprises a plurality of transverse elements 5 having a proximal end 5′ arranged in proximity of the substrate 2 and a distal end 5″ arranged at a distance from the proximal end 5′. The distance between the proximal end 5″ and the distal end 5″ may be from 1 cm to 20 cm. The transverse elements 5 are arranged substantially perpendicularly to the substrate 2. It is further conceivable that the transverse elements 5 are arranged at different angles relative to the substrate 2. Such an embodiment offers the advantage of enhanced optical performance of the light emitting device 1.

Each transverse element of the plurality of transverse elements has a length Ld in the longitudinal direction essentially parallel to the plane of the substrate, a thickness T, and a height H from the proximal end to the distal end. The thickness T and the height H are measured perpendicular to the light direction. The height H of the transverse elements is measured substantially perpendicularly to the plane of the substrate, e.g. 90°±10° to the substrate. The length, height and/or thickness of each transverse element may be same as or different from the length, height and/or thickness of the other transverse elements.

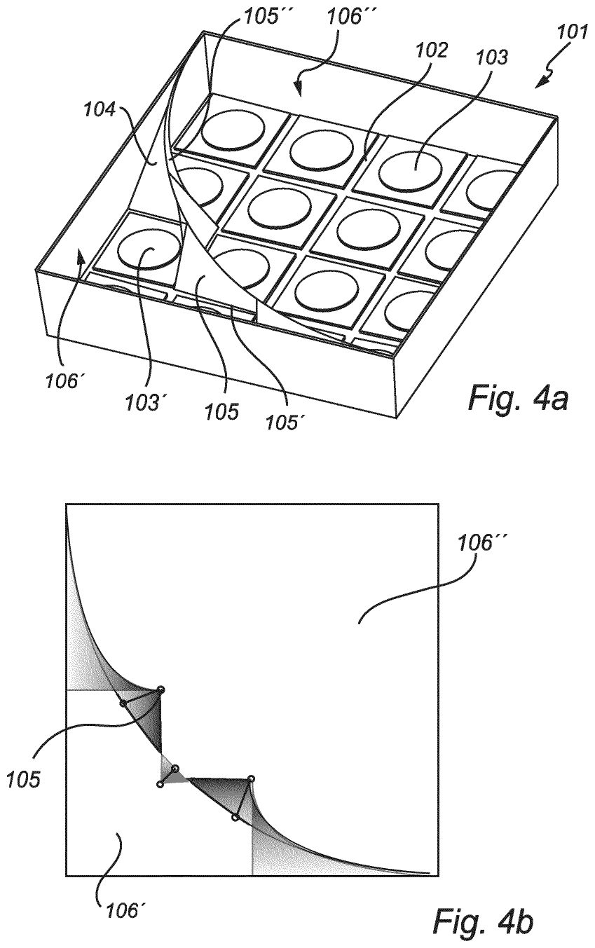

The plurality of transverse elements 5 divides the substrate 2 into at least a first segment 6′ comprising a first group of the light sources 3′, a second segment 6″ comprising a second group of the light sources 3″, and a third segment 6′″ comprising a third group of light sources 3′″. The different groups of light sources 3′, 3″ and 3′″ may be operated individually such that desired pattern is created. The number of segments may be at least five, at least ten or at least fifteen. Increased number of segments provides for an increased number of available patterns. The different patterns that may be provided by the insert are depicted in FIGS. 3A-3C.

The plurality of transverse elements 5 are arranged in a combination of straight configuration and curved configuration. In particular, the insert 4 comprises eight curved transversed elements and four straight elements. The transverse elements 5 are intersecting.

The light emitting device 1 comprises a light exit window 8 being arranged substantially parallelly to the substrate 2 such that the distal end 5″ of the at least one transverse element 5 is arranged in contact with the light exit window 8.

The light exit window 8 may be a diffuse transmissive sheet. Alternatively, or additionally, the light exit window 8 may be a light collimating plate.

The insert 4 may comprise a frame 7, and the transverse elements 5 may be arranged within the frame 7. In the shown figures the frame 7 is square, but as said it may have any suitable shape.

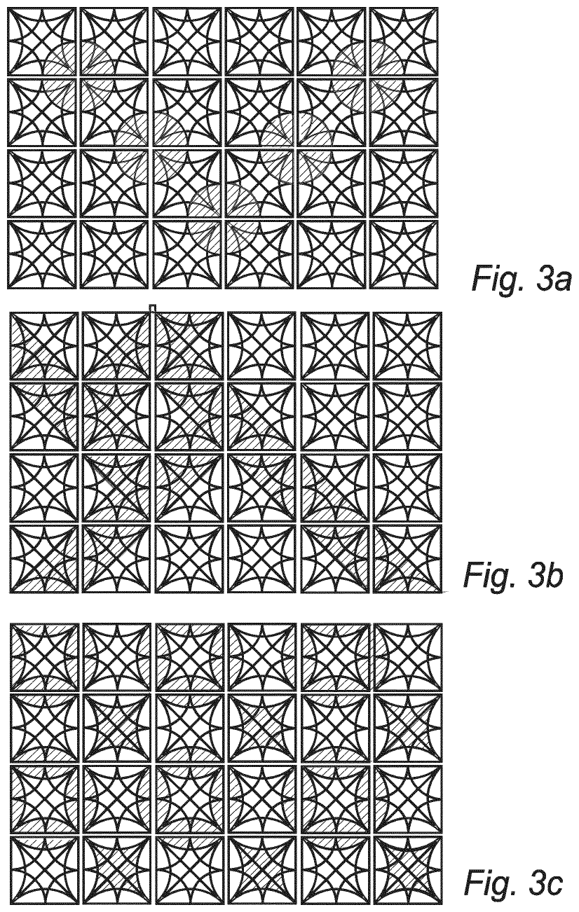

As may be seen in FIG. 2, the light sources 3′, 3″ and 3′″ are individually controllable. Thus, in the embodiment shown in FIG. 2, the first group of light sources 3′ in the first segment 6′ is switched off, while the second and the third groups of the light sources 3″ and 3′″ are switched on.

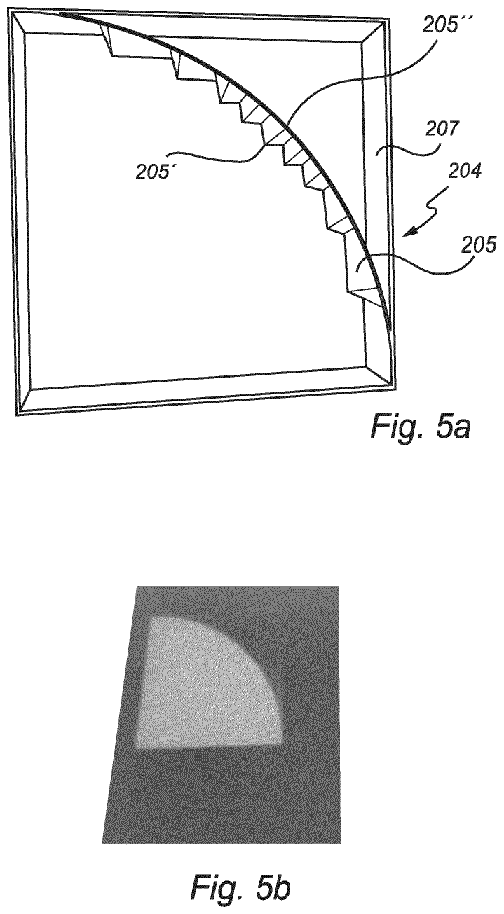

FIG. 4a depicts a light emitting device 101 comprising a substrate 102. As mentioned above, depending on the configuration of the light sources 103 and the transverse elements 105 of the insert 104, at least one light source may become covered by a transverse element, which impairs the contrast between the segments of the light emitting device resulting in a poor optical pattern. In order to avoid this undesired effect, the proximal end 105′ of at least one transverse element 105 may be non-straight, as shown in FIG. 4A and 4B. In such an embodiment, the proximal end 105′ of the at least one transverse element 105 would not intersect any light source of the plurality of light sources 103. The term “non-straight” in the context of the present invention may mean a stepped or a zig-zac configuration.

As mentioned above, the distal end 105″, 205″ and 305″ of each transverse element 105, 205, 305 may be straight or smoothly curved. The proximal end 105′, 205′, 305′ of each transverse element 105, 205, 305 may be straight, stepped straight or stepped curved. As mentioned above, stepped straight or stepped curved configuration offers the advantage of avoiding intersection of the transverse elements with the light generating/emitting part of any light source 106 of the plurality of light sources, as illustrated in FIG. 4a. As may be seen in FIGS. 4a, 5a and 6a, when the proximal end has a stepped profile and the distal end is smoothly curved, viewed in projection on a plane along the height of the transverse elements, the transverse element gradually transforms/changes in shape over its height from the stepped profile to the smooth profile.

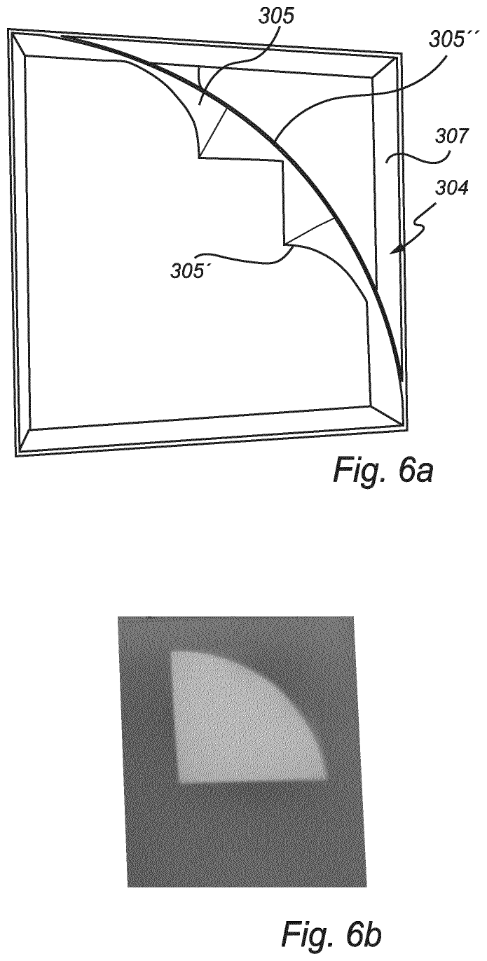

FIG. 5A depicts an embodiment of a light emitting device 201 comprising a substrate 202 and an insert 204 wherein the proximal end 205′ of the insert 205 has a pleated configuration, thus providing a sharp contract as may be seen in FIG. 5B. Such an insert may be used if the light emitting device comprises many small light sources. Another embodiment is shown in FIG. 6A, wherein the proximal end 305′ of the insert 305 has only two non-straight portions. As may be seen in FIG. 6B, even in this case the contrast between the illuminated and the non-illuminated segments is good.

The person skilled in the art realizes that the present invention by no means is limited to the preferred embodiments described above. On the contrary, many modifications and variations are possible within the scope of the appended claims. For example, if the emitted light is highly directional it would not need a beam shaping element to fulfill the requirement of this invention.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A light emitting device comprising:
a substrate comprising a plurality of individually controllable light sources adapted for, in operation, emitting light,
at least one insert comprising at least partially light-blocking material and having a longitudinal extension being parallel to said substrate, said insert comprising a plurality of transverse elements having a proximal end arranged in proximity of said substrate and a distal end arranged at a distance from said proximal end, said transverse elements being substantially perpendicular to said substrate, said plurality of transverse elements dividing said substrate into at least a first segment comprising a first group of said light sources, a second segment comprising a second group of said light sources, and a third segment comprising a third group of light sources,
wherein said proximal end of said at least one transverse element does not intersect any light source of said plurality of light sources, and
wherein the transverse element gradually transforms/changes in shape over its height to a different profile at the distal end.

2. The light emitting device according to claim 1, wherein said distal end of said transverse element has a thickness below 0.2 mm.

3. The light emitting device according to claim 1, wherein said transverse elements are intersecting.

4. The light emitting device according to claim 1, wherein said insert comprises a frame and wherein said transverse elements are arranged within said frame.

5. The light emitting device according to claim 1, wherein at least one transverse element in said plurality of transverse elements comprises a reflective coating.

6. The light emitting device according to claim 1, wherein said plurality of light sources {3} is arranged in parallel rows across said substrate.

7. The light emitting device according to claim 1, wherein said proximal end of said at least one transverse element is non-straight.

8. The light emitting device according to claim 1, wherein said light emitting device further comprises a light exit window being arranged substantially parallelly to said substrate such that said distal end of said at least one transverse element is arranged in proximity of or in contact with said light exit window.

9. The light emitting device according to claim 8, wherein said light exit window is a diffuse transmissive sheet.

10. The light emitting device according to claim 8, wherein said light exit window is a light collimating plate.

11. The light emitting device according to claim 8, wherein at least said distal end of said transverse element is white.

12. The light emitting device according to claim 1, wherein the proximal end has a stepped profile and the distal end is smoothly curved, and wherein the transverse element gradually transforms/changes in shape over its height from the stepped profile to the smooth profile.

13. The light emitting device according to claim 1, wherein said insert is manufactured by a fused deposition moulding (FDM).

14. A luminaire comprising a light emitting device according to claim 1 and a fixation element configured to support the light emitting device.

15. The luminaire according to claim 14, wherein said luminaire is configured for a suspended configuration.
